(19) United States
(12) Patent Application Publication
(10) Pub. No.: US 2018/0178439 A1
(43) Pub. Date: Jun. 28, 2018

(54) Low-temperature deformable thermoplastic device

(71) Applicants: Alexis ROBERT, Bry-sur-marne (FR); Pierre-Louis BOYER, Paris (FR)

(72) Inventors: Alexis ROBERT, Bry-sur-marne (FR); Pierre-Louis BOYER, Paris (FR)

(21) Appl. No.: 15/579,618

(22) PCT Filed: Jul. 1, 2016
(86) PCT No.: PCT/EP2016/065590

§ 371 Date: Dec. 5, 2017

(30) Foreign Application Priority Data
Jul. 3, 2015 (FR) 15 56348

(51) Int. Cl. B29C 51/42; B32B 5/02; B32B 5/18; B32B 25/20; B32B 25/04; B32B 25/08; B29C 39/10; B32B 25/10; B32B 3/26; B29C 51/14; H05B 3/00; H05B 3/14; H05B 3/36

(52) U.S. Cl. CPC B29C 51/421; B29K 2067/046; B32B 5/18; B32B 25/20; B32B 25/045; B32B 25/08; B29C 39/10; B32B 25/10; B32B 3/266; B29C 51/14; H05B 3/0004; H05B 3/145; H05B 3/36; B32B 2264/108; B32B 2307/202; B32B 2307/738; B32B 2266/0278; B32B 5/024

(57) ABSTRACT

The present invention relates to a deformable device (10), including a first thermoplastic material (40), said first material being substantially rigid at a temperature lower than a first threshold (T₁) and malleable at a temperature higher than said first threshold (T₁), said first threshold (T₁) preferably being comprised between 40° C. and 90° C. The device includes an outer shell (16) made of at least one second flexible material (42), said outer shell defining an inner recess (18), the first material (40) filling the inner recess, the at least one second flexible material (42) forming the outer shell being in solid state at least until a second temperature threshold (T₂) higher than the first threshold (T₁) by 10° C., preferably by 20° C.

The current invention relates to a deformable device, including a first thermoplastic material, said first material being substantially rigid at a temperature lower than a first threshold and malleable at a temperature higher than said first threshold.

The thermoplastics having a low melting point or a low glass transition temperature can be easily softened to be shape into a specific form when heated, and then retain this specific form after cooling. Such a thermoplastic material is notably known from the document CN101747598.

However, at a temperature higher than their melting point, such thermoplastics take generally a viscous mechanical behavior that makes them difficult to handle. The field of use of such materials is thereby limited.

The current invention aims to solve this problem. To this end, the invention is related to a deformable device of the aforementioned type, including an outer shell formed of at least a second flexible material, this outer shell delimiting an inner casing, the first material filling the inner casing. The at least one second flexible material forming the outer shell is in the solid state at least until a second temperature threshold higher than the first threshold by 10° C., preferably by 20° C.

According to other advantageous aspects of the invention, the deformable device includes one or more of the following characteristics, taken singly or in any possible technical combinations:
The first threshold is between 40° C. and 90° C.;
The first thermoplastic material is composed of a thermoplastic polymer, preferably selected among a polycaprolactone, a polylactic acid and a polycarbonate.
The first thermoplastic material is composed of an electrically and/or thermally conductive agent, said agent being preferably composed of carbon particles;
The first thermoplastic material is composed of a polycaprolactone and carbon black, a total percentage by weight of polycaprolactone and carbon black preferably being higher than or equal to 95%, a weight percentage of carbon black preferably being between 10% and 23%, more preferably between 15% and 20%;
The at least one second flexible material is an elastomer, preferably a silicone;
The inner casing is filled with the first thermoplastic material and has the shape of a first layer interposed between second and third layers of the second flexible material;
The first layer is crossed by several connections that are made of the second flexible material, said connections linking the second and third layers, said connections being preferably evenly distributed over the surface of the first layer;
The device further comprises an electrical apparatus in contact to the first thermoplastic material, said apparatus being capable of transferring heat by Joule effect to the first thermoplastic material;

Also, the invention includes a manufacturing process of a device of the aforementioned type, comprising the following steps: making of a first layer of the first thermoplastic material; then making of a second layer of the second flexible material; then positioning of the first layer on the second layer; then casting of the second flexible material in the liquid state on the first and second layers to form the third layer, and then solidification of said the second material.

Also, the invention includes a using process of a device of the aforementioned type, comprising the following steps: heating up of the first thermoplastic material to raise it to a temperature between the first threshold and the second threshold; then shaping of the device to a specific form; then cooling down of the first thermoplastic material to a temperature below the first threshold.

Preferably, the device includes an electric apparatus as described above and the heating of the first thermoplastic material is performed by this electrical apparatus.

The invention will be better understood with the following description, given only as an example and with reference to the drawings:

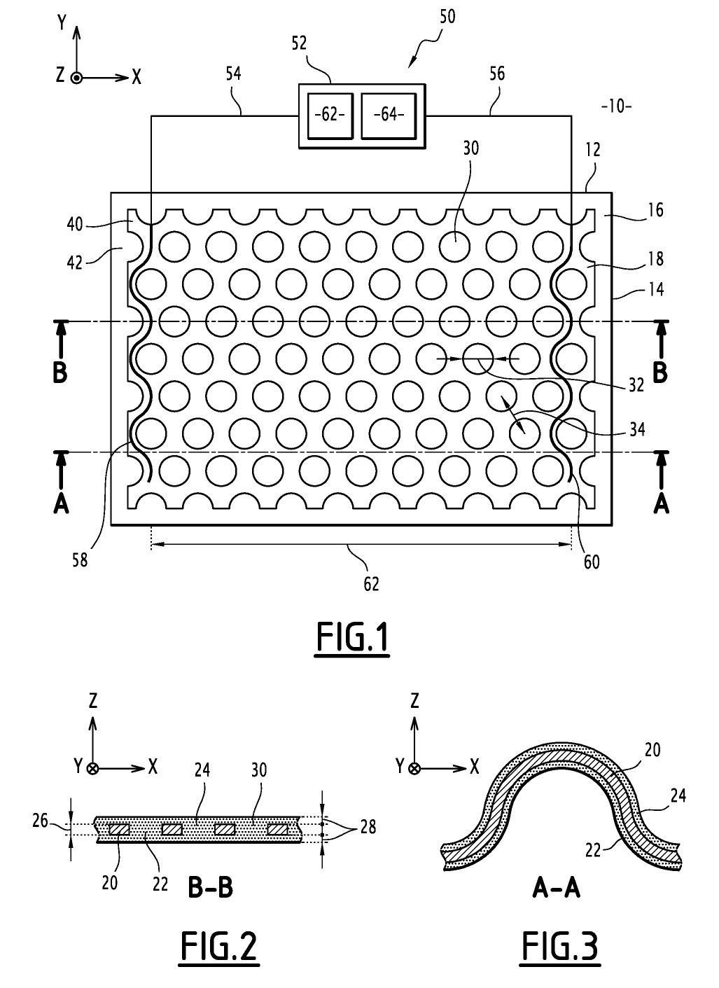

FIG. 1 is a schematic view from above of a device in a first configuration according to one configuration of the invention;

FIG. 2 is a partial view, in section, of the device of FIG. 1 in the first configuration; and

FIG. 3 is a partial view, in section, of the device of FIG. 1 in a second configuration.

FIGS. 1 to 3 show a device 10 according to one configuration of the invention. In the following description, we consider an orthonormal basis (X, Y, Z), the Z direction being the vertical one.

On FIGS. 1 and 2, the device 10 is in a first configuration, substantially flat along a plane (X, Y). The device 10 has, for example, a rectangular contour, with edges 12, 14 respectively parallel to the X and Y directions.

The device 10 includes an outer shell 16 that delimits an inner casing 18. The inner casing 18 is preferably closed.

In the configuration shown in FIGS. 1 to 3, the inner casing 18 forms a first layer 20 that is interposed between a second 22 and a third layer 24 of the outer shell 16.

In the first configuration of FIGS. 1 and 2, the layers 20, 22, 24 are flat, arranged substantially along (X, Y) and stacked along Z. For example, as shown in FIG. 2, the first layer 20 has a thickness 26 along Z, between 1 mm and 5 mm; the second 22 and third 24 layers have a thickness 28 substantially identical, between 0.5 mm and 5 mm.

Preferably, the dimensions of first layer 20 along X and. Y are inferior to the dimensions of the second 22 and third 24 layers. Thus, near the edges 12, 14, the second 22 and third 24 layers are in contact with each other continuously, to close the inner casing 18.

Preferably the outer shell 12 comprises several connections 30 that cross first layer 20 along Z and link second 22 and third 24 layers.

The inner casing 18 thus has the shape of a mesh disposed between the connections 30. For example, according to the section plane AA of FIG. 3, away from the connections 30, the first layer 20 is continuous according X. However, according to the section plane BB of FIG. 2, via 30 connections, the first layer 20 is discontinuous along X.

Preferably, the connections 30 are substantially identical and/or evenly distributed over a surface of the first layer 20. For example, as shown in FIG. 1, the connections 30 have a circular section in a plane (X, Y), the centers of these circles being disposed at the top of equilateral triangles.

Alternatively, the connections 30 have for example an oval or polygonal section.

The inner casing 18 is filled with a first thermoplastic material 40 that forms the first layer 20. The first material 40 is substantially rigid at a temperature lower than a first threshold T₁. Beyond first threshold T₁, the first material 40 is malleable or liquid. The first threshold T₁ is inferior or equal to a glass transition temperature and/or any melting temperature of the first material 40.

Preferably, the first threshold T₁ is between 40° C. and 90° C.

The outer shell 12 is formed of at least a second material 42. In the following description, it is assumed that the outer shell 12 is formed of one material 42, and in particular, the second 22 and third 24 layers are formed of the same material 42. However, according to an alternative configuration, the second 22 and third 24 layers are formed from two different materials, each of these materials having the physical properties described below.

At room temperature, for example between 10° C. and 30° C., the second material 42 is a flexible solid, preferably elastic. The second material 42 remains in the solid state at least until a second temperature threshold T₂ higher than the first threshold T₁ by 10° C., preferably by 20° C. In other words, at a temperature between T₁ and T₂, the outer shell 12 is made of a flexible solid material and contains a malleable or liquid material 40 in the inner casing 14.

Preferably, the second flexible material 42 is electrically insulating to prevent electrical shock to the user.

According to a first alternative configuration, shown in FIGS. 1 to 3, the second flexible material 42 is an elastomer, notably in single monolithic form, as a single piece. The elastomer is in particular a silicone.

According to a second configuration not shown, the second flexible material 42 is a foam, for example a polyurethane foam. The advantage of the foams is that they allow an electric insulation while imparting lightness to the device, and a deformation that is potentially more consistent than a deformation caused by an elastomer.

According to a third alternative configuration not shown, the second flexible material 42 is a woven material, including for example fibers of cotton and/or polyester.

Tissues and fabric have advantages that are similar to those of the foams, moreover they have the characteristic of an extremely small compactness. Manufacturing an outer shell tissue 12 may be accomplished by the usual methods of the textile industry as sewing.

The mesh of tissues and alveoli of the foams have a size and distribution chosen to avoid the outflow of the first material 40 in a malleable or liquid state.

Preferably, a main component of the first thermoplastic material 40 is a thermoplastic polymer. Said polymer is preferably selected among a polycaprolactone and a polylactic acid. More preferably, the thermoplastic polymer is a polycaprolactone whose average molecular weight is between 20,000 g·mol⁻¹ and 150,000 g·mol⁻¹. For example, a melting point of polycaprolactone is about 60° C.

Alternatively, a main component of the first thermoplastic material 40 is a polycarbonate, whose melting temperature is about 140 ° C. In this case, the first threshold T₁ is higher than 90° C. The outer shell 12 has then preferably a sufficient thickness to keep a surface temperature allowing its handling even if the first thermoplastic material 40 is in a malleable state.

Preferably, the first thermoplastic material 40 comprises an electrically and/or thermally conductive agent. More preferably, said agent comprises or id made of carbon particles such as carbon black, graphite powder or carbon nanotubes. Alternatively, said agent comprises or is made of metal particles such as copper powder.

According to one configuration, the first thermoplastic material 40 also comprises fillers, or additives such as UV or oxidation protection agents.

Preferably, the first thermoplastic material 40 comprises a polycaprolactone and carbon black, a total percentage by weight of polycaprolactone and carbon black being higher than or equal to 95% relative to the total weight of the first thermoplastic material 40. More preferably, a percentage by weight of carbon black is between 10% and 23%, even more preferably between 15% and 20%, based on the total weight of the first thermoplastic material 40.

According to a preferential configuration, as shown in FIG. 1, the device 10 includes an electrical device 50, capable of transferring heat by Joule effect to the first thermoplastic material 40. The electrical device 50 includes for example a control unit 52, and two electrodes 54, 56 connected to said control unit 52. According to this configuration, the first thermoplastic material 40 is chosen to be electrically conductive, its resistivity being adapted to convert to heat the desired amount of electrical energy that passes through it.

Preferably, each electrode 54, 56 includes a wire 58, 60 inserted into the first layer 20 in contact with the first material 40. Each wire 58, 60 is formed of an electrically conductive material, preferably metallic.

Preferably, the wires 58, 60 extend in the first layer 20 along two substantially parallel paths. In the example of FIG. 1, the wires 58, 60 extend substantially along Y direction between the two edges 12 of the device 10. More preferably, a distance 62 along X direction between the two wires 58, 60 is substantially constant over the entirety of their length, to obtain a homogeneous resistance and thermal diffusion in the first material 40.

The wires 58, 60 are advantageously positioned as close to the edges 14 parallel to Y as possible, so that the heat is distributed over a wide area of the device 10.

Preferably, the wires 58, 60 have an undulating path in the first layer 20, to allow a stretching of the device 10 according to their main direction. In the example in FIG. 1, the wires 58, 60 twist around connections 30 of second material 42. Preferably, the wires 58, 60 bypass connections 30 instead of passing through them.

Preferably, a first end of each wire 58, 60 is connected to the control unit 52 and a second end is embedded in the first layer 20.

Preferably, the inner casing 18 has a substantially constant area section between the two wires 58, 60. Specifically, the first layer 20 has a substantially constant area section in the X direction between the two wires 58, 60. The thermal diffusion by Joule effect is thus substantially homogeneous at any point of the first layer 20 between the wires 58, 60.

Preferably, the control unit 52 includes a power source 62, such as a battery. Alternatively, the control unit 52 includes means to connecting the wires 58, 60 to an external power supply.

Preferably, the control unit 52 also includes an electronic device 64 which controls the distribution of electrical power into the electrodes 54, 56, Said electronic device 64 includes in particular an electronic card. For example, the electronic device 64 is capable of regulating the amount of distributed energy or the duration of energy delivery.

Alternatively, the electronic device 64 is connected to a temperature probe (not shown) in contact with the first layer 20. For example, the electronic device 64 is capable of stopping the delivery of electrical energy when the temperature of the first material 40, measured by said probe, exceeds a third threshold T₃. The third threshold T₃ is, for example, between the first T₁ and second. T₂ thresholds.

A manufacturing process of the device 10 will now be described. A first layer 20 is made of the first thermoplastic material 40. For example, the first material 40, heated up to a temperature higher than or equal to T₁, is shaped as a plate, notably by extrusion, compression, or calendering using a steamroller. The formed plate is then perforated with openings corresponding to the locations of connections 30. Alternatively, the plate can be directly formed with apertures corresponding to the locations of the connections 30, for example by molding.

The wires 58, 60 are then arranged on the plate of the first material 40. Preferably, the wires are slightly recessed in the plate, the material 40 being in a softened state. Alternatively, the wires can be incorporated simultaneously with the formation of the plate.

In the meantime, the second material 42, for example an elastomer in the liquid state, is poured into a mold to form the second layer 22. After partial curing of said second layer, the first layer 20 is laid over it.

Some of the second material 42 in the liquid state is then poured into a mold on the first 20 and second 22 layers to form the third layer. The second material 42 then fills the openings in the first layer 20, forming the connections 30. The crosslinking of the second material 42 at the edges 12, 14 and connections 30 secure together the second 22 and third 24 layers.

Alternatively, the first layer 20 is maintained in an appropriate position in a mold and the second 22 and third 24 layers are formed at once by pouring or injecting the second flexible material 42 in said mold.

According to a variant configuration, the second 22 and third 24 layers are formed from two different materials, able to weld mechanically to each other during polymerization, each of said materials having the physical properties described above. The two different materials are, for example, two different types of silicone.

The wires are then connected to a control unit 52 to form the electrodes 54, 56. The device 10 as described above is thus obtained.

A using process of the device 10 will now be described. In an initial state, the device 10 is, for example, in the first configuration shown in FIGS. 1 and 2. The first material 40 is in a rigid state. The ambient temperature is for example between 10° C. and 30° C.

The first layer 20 is then heated up to get the first material 40 to a temperature between the first threshold T₁ and the second threshold T₂. In the case of device 10 shown in FIG. 1, the control unit 52 transfers, for example, electrical energy to the first material 40 via the electrodes 54, 56. Alternatively, the device 10 is heated up by another means, for example, by soaking in hot water.

Under the action of heating, the first material 40 passes to a viscous fluid state, able to change shape. The device 10 is then deformed to bend and/or stretch the outer casing 16. The device 10 is, for example, placed in a second curved configuration, shown in FIG. 3,

The device 10 is maintained in the second configuration during a cooling phase of the first material 40. When the temperature of said material goes below the first threshold T₁, the first material 40 regains its rigidity and retains the shape adopted in the second configuration. The outer shell 16 is then maintained in the second configuration by the first material 40.

One possible application of the device 10 is in particular the use as a component of a seat element for individual in means of transport, or paramedical splint, or children's toy, or clothing, or massage accessory.

The examples below illustrate the invention without limiting it.

### EXAMPLE 1

### Preparation of the First Thermoplastic Material 40

A first material 40 is made from polycaprolactone (commercially available from Perstorp under the designation “CAPA 6500”) with a melting temperature Tₘ=60° C. and an average molecular weight of 50,000 g·mol⁻¹. The polycaprolactone is mixed with powdered carbon black (available from Cabotcorp under the designation “Black Pearl 2000”) by grinding in a mortar heated up to 80° C. The first material 40, hereinafter referred to as PCL-BP, is thus obtained in the form of a homogeneous paste.

Table 1 below shows the electrical resistivity of PCL-BP in function of the mass percentage of carbon black:

TABLE 1

Carbon black (% by weight)

| | 10 | 12.50 | 15 | 17.5 | 20 | 22.5 |
|---|---|---|---|---|---|---|
| Resistivity | [symbol] | 72554 | 0.414 | 0.118 | 0.031 | 0.025 |
| (Ohm · m) | | | | | | |

Beyond 23% carbon black in the mixture, the material obtained is brittle.

### EXAMPLE 2

### Manufacture of the Device 10

A plate PCL-BP with 20% by weight of carbon Hack is made using a roller. Referring to FIG. 1, the plate has a thickness 26 of between 1.5 mm and 3 mm, and dimensions along X direction and Y direction of 27 cm and 23 cm respectively.

The plate thus produced is then perforated with circular holes of diameter 32 of 5 mm (FIG. 1). The centers of the circles are arranged at the top of equilateral triangles of side 34 of 7 mm (FIG. 1), one of the sides of the triangles being parallel to X direction.

Wires of copper 58, 60 are then embedded in the plate PCL-BP, according to parallel paths arranged substantially along Y direction.

A first layer of silicone (commercially available from Creation Silicone under the designation “Dragon Skin 10 fast”) is poured into a rectangular mold of dimensions along X direction and Y direction of 30 cm and 26 cm respectively. Referring to FIG. 1, the plate has a thickness 28 of between 1.5 mm and 3 mm.

After partial curing of the first layer of silicone, the perforated plate PCL-BP is laid down on said layer. A second layer of silicone is then poured over the plate PCL-BP. After complete curing of the silicone, the two layers are joined and form the outer casing 16 of the device 10.

One end of the copper wires 58, 60 is then connected to a control unit 52 to form the electrodes 54, 56.

1. A deformable device (10), including a first thermoplastic material (40), said first material being substantially rigid at a temperature lower than a first threshold (T₁) and malleable at a temperature higher than said first threshold (T₁), said first threshold (T₁) preferably being comprised between 40° C. and 90° C. The device includes an outer shell (16) made of at least one second flexible material (42), said outer shell defining an inner recess (18), the first material (40) filling the inner recess, the at least one second flexible material (42) forming the outer shell being in solid state at least until a second temperature threshold (T₂) higher than the first threshold (T₁) by 10° C., preferably by 20° C.

2. The device of claim 1, wherein the first thermoplastic material (40) includes a thermoplastic polymer, preferably selected among a polycaprolactone, a polylactic acid and a polycarbonate.

3. The device of claim 1 or claim 2, wherein the first thermoplastic material includes an electrically and/or thermally conductive agent, said agent being preferably formed of carbon particles.

4. The device of one of the preceding claims, wherein the first thermoplastic material includes a polycaprolactone and carbon black, a total percentage by weight of polycaprolactone and carbon black preferably is higher than or equal to 95%, a percentage mass of carbon black preferably is between 10% and 23%, more preferably between 15% and 20%.

5. The device of one of the preceding claims, wherein the at least one second flexible material (42) is an elastomer, preferably a silicone.

6. The device of one of claims 1 to 4, wherein the at least one second flexible material (42) is a foam, preferably a polyurethane foam.

7. The device of one of the preceding claims, wherein the at least one second flexible material (42) is a woven material, preferably including fibers of cotton and/or polyester.

8. The device of one of the preceding claims, wherein the inner casing (18) is filled with the first thermoplastic material (40) and has the shape of a first layer (20) interposed between a second (22) and third (24) second flexible material layer (42).

9. The device of claim 8, wherein the first layer is crossed by several connections that are made of the second flexible material, said connections linking the second and third layers, said connections being preferably evenly distributed over the surface of the first layer.

10. The device of one of the preceding claims, further comprising an electrical apparatus (50) in contact with the first thermoplastic material, said apparatus being capable (52, 54, 56) of transferring heat by Joule effect to the first thermoplastic material.

11. A manufacturing process of the device (10) of one of claims 8 to 10, comprising the following steps:
Making of a first layer (20) of the first thermoplastic material;
Making of a second layer (22) of the second flexible material;
then:
Positioning of the first layer on the second layer; then
Casting of the second flexible material in the liquid state on the first and second layers to form the third layer (24), and solidification of said the second material.

12. A using process of the device (10) of one of claims 1 to 10 comprising the following steps:
Heating up of the first thermoplastic material (40) to a temperature between the first threshold (T₁) and the second threshold (T₂); then
Shaping of the device in a form; then
Cooling down of the first thermoplastic material (40) to a temperature lower than the first threshold (T₁).

13. A using process according to claim 12, in combination with claim 10, wherein heating the first thermoplastic material is performed by means of the electrical apparatus (50).
